(19) United States
(12) Patent Application Publication
(10) Pub. No.: US 2025/0116503 A1
(43) Pub. Date: Apr. 10, 2025

(54) IMAGE MEASURING APPARATUS AND PROGRAM

(71) Applicant: MITUTOYO CORPORATION, Kawasaki (JP)

(72) Inventors: Hiroyuki Yoshida, Kanagawa (JP); Yuji Sadahira, Kanagawa (JP); Yuki Yamasaki, Kanagawa (JP)

(21) Appl. No.: 18/906,577

(22) Filed: Oct. 4, 2024

(30) Foreign Application Priority Data
Oct. 10, 2023 (JP) 2023-175466

(51) Int. Cl. G01B 11/00; G01B 11/03; G06T 7/00

(52) U.S. Cl. CPC G01B 11/005; G01B 11/03; G06T 7/0006; G06T 2207/30164

(57) ABSTRACT

An image measuring apparatus includes: a CAD data storage unit that stores CAD data of at least one object and CAD data information including designed dimensions extracted from the CAD data, measurement points corresponding to the design dimensions, and edge detection tool conditions used to detect the edges of the measurement points in advance for each different CAD data; a CAD data retrieval unit that retrieves CAD data from the CAD data storage unit that are similar in shape to the measurement object represented in the captured image; a CAD data setting unit that performs best-fit of the CAD data identified based on the retrieval to the image of the measurement object as the CAD data of the measurement object, and sets the coordinate system of the CAD data; and a measurement performing unit that performs edge detection and dimensional measurement for each measurement point using the CAD data information.

### CROSS-REFERENCE TO RELATED APPLICATION

This non-provisional application claims priority under 35 U.S.C. § 119 (a) from Japanese Patent Application No. 2023-175466, filed on Oct. 10, 2023, the entire contents of which are incorporated herein by reference.

### BACKGROUND OF THE INVENTION

### Field of the Invention

The present invention relates to an image measuring apparatus and program.

### Description of the Related Art

An image measuring apparatus is a device that captures an image of a measurement object and measures the dimensions of the measurement point of the measurement object by analyzing the image (see, for example, JP2010-169584A).

### SUMMARY OF THE INVENTION

### Problems to be Solved by the Invention

Conventionally, when performing image measurement, it was necessary to prepare a part program in advance for each measurement object that records measurement contents and procedures, set a measurement coordinate system according to the position and orientation of the measurement object on a mounting table, and manually set an edge detection tool that specifies the range of edge detection process for each measurement point.

An object of the present invention is to provide an image measuring apparatus and program that can reduce the work conventionally required at the time of image measurement.

### Means for Solving the Problems

An image measuring apparatus according to the present invention captures an image of a measurement object and measures the dimensions of the measurement point of the measurement object by analyzing the image. The image measuring apparatus comprises: a CAD data storage unit that stores CAD data of at least one object and CAD data information including designed dimensions extracted from the CAD data, measurement points corresponding to the design dimensions, and edge detection tool conditions used to detect the edges of the measurement points in advance for each different CAD data; a CAD data retrieval unit 41 that retrieves the CAD data from the CAD data storage unit that are similar in shape to the measurement object represented in the captured image; a CAD data setting unit that performs best-fit of the CAD data identified based on the retrieval to the image of the measurement object as the CAD data of the measurement object, and sets the coordinate system of the CAD data that has been best-fit as the measurement coordinate system; and a measurement performing unit that performs edge detection and dimensional measurement for each measurement point using the CAD data information corresponding to the CAD data of the measurement object for the image of the measurement object.

The image measuring apparatus may further comprise a display unit. The CAD data setting unit may cause the display unit to display the CAD data of the measurement object that has been best-fit superimposed on the image of the measurement object, and the measurement performing unit may cause the display unit to display the measurement results at the display position of the design dimensions for each measurement point in the CAD data of the measurement object.

The CAD data information may include information on the tolerance of the design dimensions, and the measurement performing unit may cause the display unit to identifiably display, for each measurement point, that the measurement result is out of the tolerance range of the design dimensions, if the result is out of the range.

The functions of the image measuring apparatus of the present invention may be described in a program, and the functions of the image measuring apparatus of the present invention may be realized by making a computer execute the program.

### Effect of the Invention

According to the image measuring apparatus and program, the work required conventionally in image measurement, such as creating the part program, setting the measurement coordinate system, and setting the edge detection tool, can be omitted, thereby reducing the work involved in image measurement.

### BRIEF DESCRIPTION OF THE DRAWINGS

FIG. 1 shows an example of the appearance of an image measuring apparatus 1 that performs the image measurement method according to the present invention.

FIG. 2 shows a schematic diagram of the internal structure of the image measuring apparatus 1.

FIG. 3 shows a functional block diagram of the image measuring apparatus 1.

FIG. 4 is an example of CAD data of an object.

FIG. 5 shows an example of a captured image of the measurement object.

FIG. 6 shows an example of the best fit of CAD data to the captured image.

FIG. 7 shows an example of the display form of the measurement results.

FIG. 8 shows the manipulation of the display of measurement results.

### DETAILED DESCRIPTION OF THE EMBODIMENTS

Hereinafter, embodiments of the present invention will be described with reference to the drawings. In the following description and drawings, the same reference numeral is attached to the same functional parts, and the functional parts, once explained, are either omitted or explained to the extent necessary.

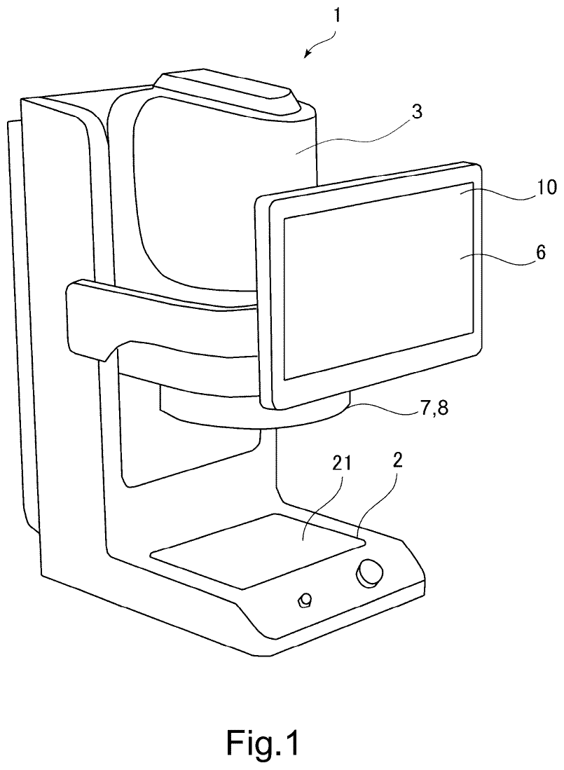

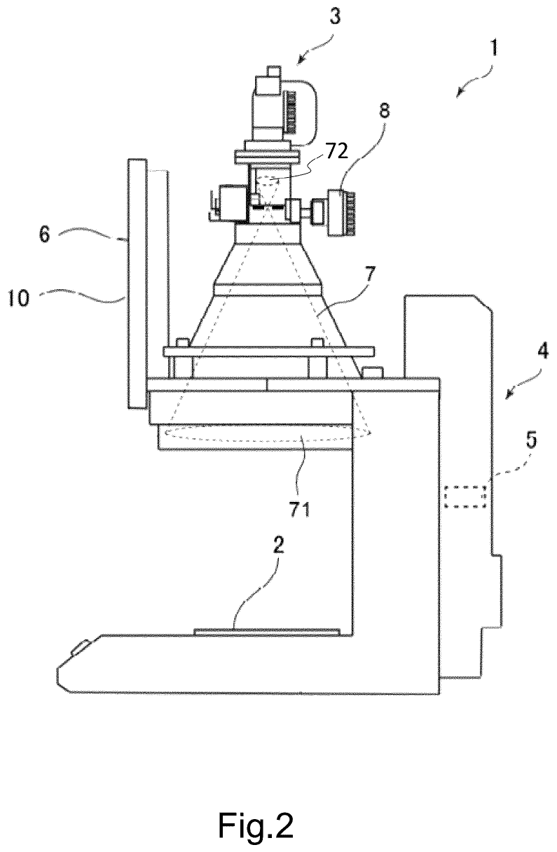

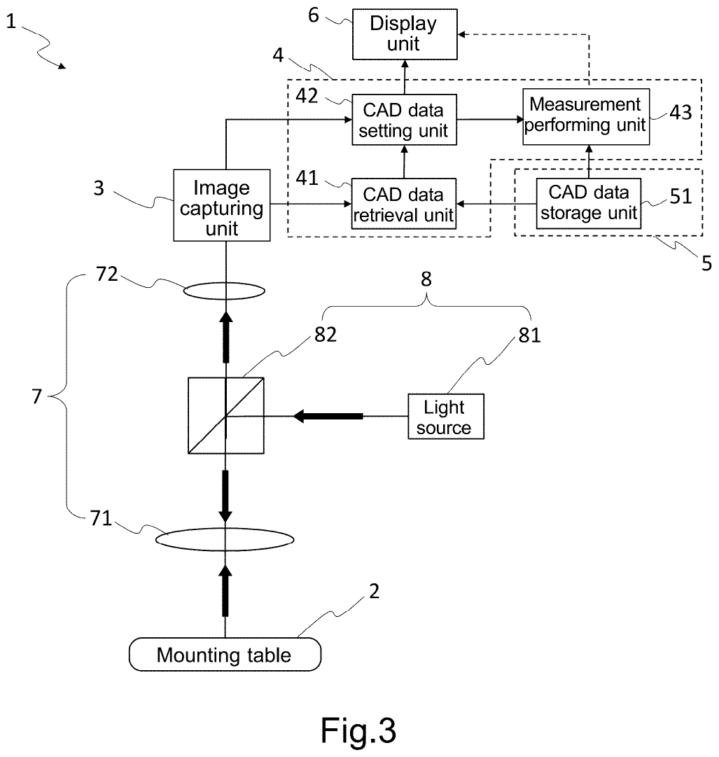

FIG. 1 is a schematic diagram showing an example of the appearance of an image measuring apparatus 1. FIG. 2 is a schematic diagram showing the internal structure of the image measuring apparatus 1. FIG. 3 shows a functional block diagram of the image measuring apparatus 1. In the present embodiment, the case in which the coaxial episcopic illumination is adopted as the illumination method will be explained as an example, but any illumination method is acceptable as long as the image of the measurement object can be captured.

The image measuring apparatus 1 includes a mounting table 2, an image capturing unit 3, control processing unit 4, a storage unit 5, a display unit 6, a telecentric optical system 7, an illumination unit 8, and an operation unit 10.

The mounting table 2 is a platform on which a measurement object (not shown in the drawings) is placed.

The image capturing unit 3 is disposed opposite the mounting table 2 and captures images by receiving light from the direction of the mounting table 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The display unit 6 is an arbitrary display means, and displays the image captured by the image capturing unit 3 etc.

The telecentric optical system 7 includes an objective lens 71 that collects light from the direction of the mounting table 2 and an imaging lens 72 that forms an image of the light arriving through the objective lens 71 on the light-receiving surface of the image capturing unit 3. The objective lens 71 and the imaging lens 72 may have a plurality of lens surfaces, respectively.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting table 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The operation unit 10 is an input means for entering information necessary for measurement. FIGS. 1 and 2 show an example in which a touch panel display is employed and configured integrally with the display unit 6, but the operation unit 10 may be configured as an independent input means.

The storage unit 5 is an arbitrary storage means capable of storing digital data. In the present invention, the storage unit 5 includes a CAD data storage unit 51.

The CAD data storage unit 51 stores CAD data of the objects and CAD data information, including designed dimensions extracted from the CAD data, measurement points corresponding to the design dimensions, and edge detection tool conditions used to detect the edges of the measurement points in advance for each different CAD data. The CAD data storage unit 51 may store the tolerances along with the designed dimensions, if necessary.

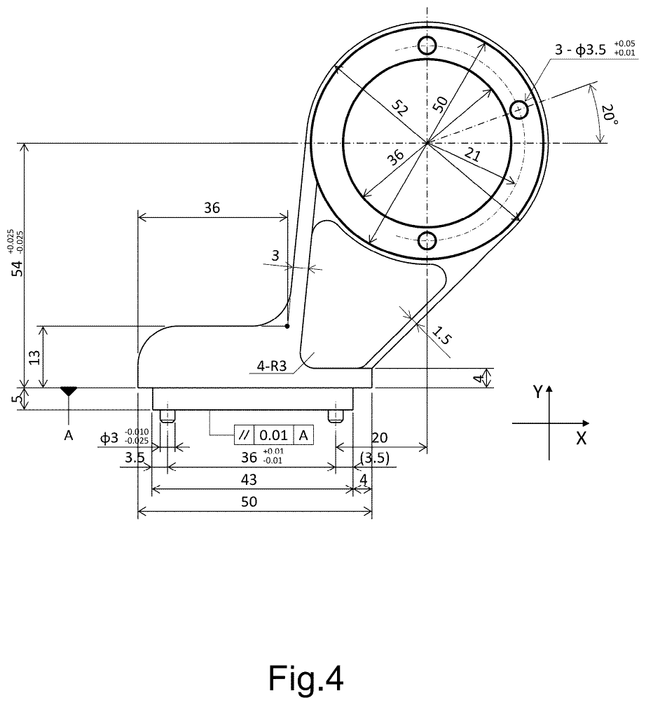

FIG. 4 shows an example of CAD data of the object. CAD data includes information such as designed dimensions, dimensional tolerances, dimension lines, dimensional auxiliary lines, and draw-out lines, along with information such as outline lines, hidden lines, and center lines that indicate the shape of the object. Therefore, for example, by following the description of the designed dimensions, the dimension lines corresponding to the designed dimensions, and the dimension auxiliary lines corresponding to the dimension lines, in that order, the location and shape of the outline lines corresponding to the designed dimensions can be identified, and the conditions of the edge detection tool to be applied to such locations can also be identified. When designing in CAD, the CAD data can include link information connecting the dimension values to the graphic elements in order to specify which graphic elements are generally used to illustrate dimensions (length, diameter, radius, or the like). Therefore, this link information may be used to improve the efficiency of the process of identifying the location and shape of outline lines or the like.

The CAD data information can be generated by such a process, but the efficiency of the generation process can also be improved by preparing application software that automatically performs such a generation process and outputs CAD data information upon input of the CAD data.

The control processing unit 4 controls each part in the image measuring apparatus 1 and performs necessary arithmetic processing to realize image capture and image measurement by the image measuring apparatus 1.

In the present invention, the control processing unit 4 includes a CAD data retrieval unit 41, a CAD data setting unit 42, and a measurement performing unit 43.

The CAD data retrieval unit 41 retrieves CAD data from the CAD data storage unit 51 that are similar in shape to the measurement object represented in the image captured by the image capturing unit 3. Any method may be used to determine similarity. CAD data that is similar to the measurement object may be identified with the highest similarity or the highest plurality may be provisionally identified. When the highest plurality is tentatively identified, for example, the display unit 6 may show the highest plurality and accept input of information identifying one of them so that one of them can be identified.

The CAD data setting unit 42 performs the best-fit of the CAD data identified based on the retrieval by the CAD data retrieval unit 41 to the image of the measurement object as the CAD data of the measurement object and sets the coordinate system of the CAD data that has been best-fit as the measurement coordinate system. Any method may be used to perform the best fit of CAD data to the image of the measurement object, such as pattern matching, parametric matching, or other methods.

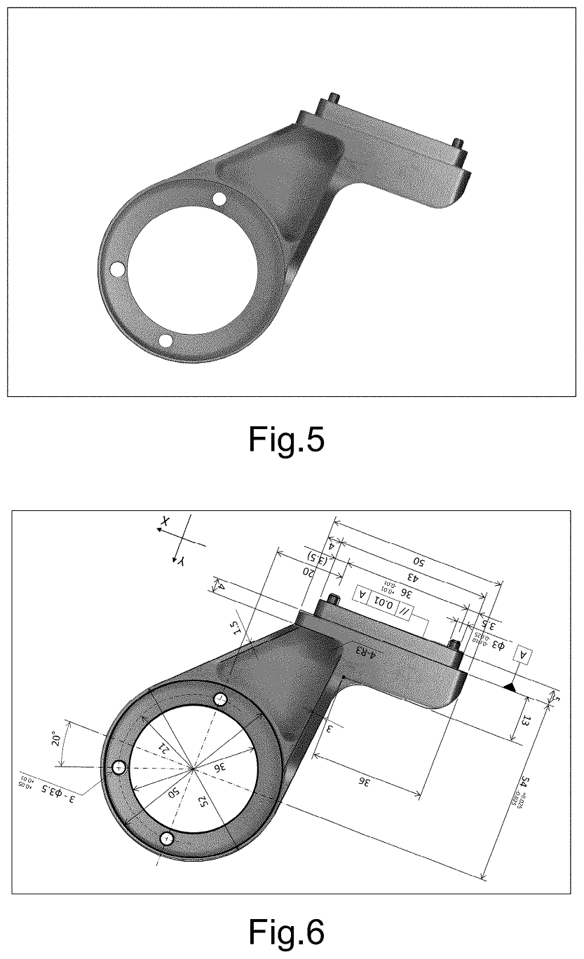

For example, when the CAD data shown in FIG. 4 is identified by the retrieval as CAD data whose shape is similar to the measurement object represented in the captured image shown in FIG. 5, the CAD data shown in FIG. 4 is best fitted to the captured image shown in FIG. 5, as shown in FIG. 6. By performing best-fit, the coordinate system of the CAD data can be set as the measurement coordinate system because the position range of the measurement object in the coordinate system of the CAD data can correspond to the position range of the measurement object in the measurement coordinate system as determined from the captured image.

The measurement performing unit 43 performs edge detection and dimensional measurement for each measurement point using the CAD data information corresponding to the CAD data of the measurement object stored in the CAD data storage unit 51 for the image of the measurement object.

For each CAD data, prior to performing the first measurement, the illumination conditions of the illumination unit 8 may be set automatically or manually to maximize the contrast of the measurement point. Furthermore, the illumination conditions set for each measurement point may be stored in the CAD data storage unit 51 as an addition to the CAD data information, and the illumination conditions may be configured to be set automatically at the time of the second and subsequent measurement.

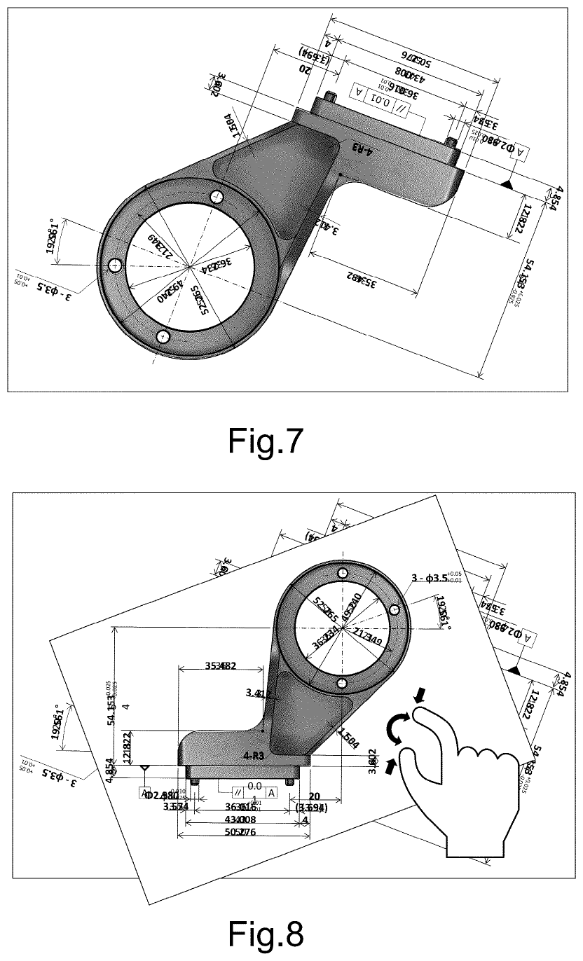

The CAD data setting unit 42 may cause the display unit 6 to display the CAD data of the measurement object that has been best-fit superimposed on the image of the measurement object, and the measurement performing unit 43 may cause the display unit 6 to display the measurement results at the display position of the design dimensions for each measurement point in the CAD data of the measurement object. An example of the display form of the measurement results is shown in FIG. 7. Although FIG. 7 shows an example of displaying the measurement results superimposed on the display of the design dimensions in the CAD data, instead of superimposing them, they may be slightly shifted, or the display of the design dimensions may be replaced by the measurement results.

The information on the tolerance of the design dimensions of the measurement points may be added to the CAD data information stored by the CAD data storage unit 51, and the measurement performing unit 43 may cause the display unit 6 to identifiably display, for each measurement point, that the measurement result is out of the tolerance range of the design dimensions, if the result is out of the range. The way of displaying the results identifiably is arbitrary. For example, the color or font of the display of the measurement results may be changed, or a statement indicating that it is out of range may be displayed at an arbitrary position.

In the present invention, the control processing unit 4 may be constituted by a CPU, and each function may be realized by executing a program that describes the functions of the CAD data retrieval unit 41, CAD data setting unit 42, and the measurement performing unit 43, as well as the functions to control the image capturing unit 3, the illumination unit 8, etc., by the CPU. The program may be read from the storage unit 5 or from another storage medium. The control processing unit 4 and the storage unit 5 may be provided in the main body of the image measuring apparatus 1 or in a personal computer or other device that is communicatively connected to the main body of the image measuring apparatus 1.

According to the image measuring apparatus and program described above, the work required conventionally in image measurement, such as creating a part program, setting the measurement coordinate system, setting the edge detection tool, and adjusting the display position of the measurement results, can be omitted, thereby reducing the work involved in image measurement.

Since the CAD data is fitted to the image of the measurement object, the display of the measurement results can be enlarged, shrunk, rotated, and scrolled on the display screen, as shown in FIG. 8. Since information on the position and orientation of the measurement object can be obtained during the fitting of CAD data by the CAD data setting unit 42, this information may be used to automatically enlarge, shrink, rotate, or move the measurement results to display them in a way that is easy for the user to read.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

What is claimed is:

1. An image measuring apparatus that captures an image of a measurement object and measures the dimensions of the measurement point of the measurement object by analyzing the image, comprising:
a CAD data storage unit that stores CAD data of at least one object and CAD data information including designed dimensions extracted from the CAD data, measurement points corresponding to the design dimensions, and edge detection tool conditions used to detect the edges of the measurement points in advance for each different CAD data;
a CAD data retrieval unit 41 that retrieves CAD data from the CAD data storage unit that are similar in shape to the measurement object represented in the captured image;
a CAD data setting unit that performs the best-fit of the CAD data identified based on the retrieval to the image of the measurement object as the CAD data of the measurement object and sets the coordinate system of the CAD data that has been best-fit as the measurement coordinate system; and
a measurement performing unit that performs edge detection and dimensional measurement for each measurement point using the CAD data information corresponding to the CAD data of the measurement object for the image of the measurement object.

2. The image measuring apparatus according to claim 1, further comprises a display unit,
wherein the CAD data setting unit causes the display unit to display the CAD data of the measurement object that has been best-fit superimposed on the image of the measurement object, and
the measurement performing unit may cause the display unit to display the measurement results at the display position of the design dimensions for each measurement point in the CAD data of the measurement object.

3. The image measuring apparatus according to claim 2,
wherein the CAD data information includes information on the tolerance of the design dimensions, and
the measurement performing unit causes the display unit to identifiably display, for each measurement point, that the measurement result is out of the tolerance range of the design dimensions, if the result is out of the range.

4. The program that causes a computer to function as the image measuring apparatus according to claim 1.
